(19) United States
(12) Patent Application Publication
(10) Pub. No.: US 2021/0060576 A1
(43) Pub. Date: Mar. 4, 2021

(54) SEWAGE TREATMENT DEVICE FOR HOUSEHOLD GARBAGE

(71) Applicant: ZHIJUN WANG, SHENZHEN (CN)

(72) Inventors: ZHIJUN WANG, SHENZHEN (CN); JINMEI ZHANG, SHENZHEN (CN)

(21) Appl. No.: 16/655,249

(22) Filed: Oct. 17, 2019

Related U.S. Application Data
(63) Continuation of application No. PCT/CN2019/106751, filed on Sep. 19, 2019.

(30) Foreign Application Priority Data
Sep. 2, 2019 (CN) 201910823740.8

(51) Int. Cl. B03C 1/02; B01F 7/00; B02C 18/14; C02F 1/52

(52) U.S. Cl. CPC B03C 1/02; B01F 7/00141; B01F 7/02; B02C 18/145; C02F 1/52; B01F 7/00583

(57) ABSTRACT

The present disclosure relates to a field of sewage treatment, specifically an efficient sewage treatment device for household garbage, which includes a machine body 1, a stirring cavity, a crushing cavity, a flocculation cavity; a filter cavity, and a water tank. The stirring cavity, the crushing cavity, the flocculation cavity, and the filter cavity are disposed inside the machine body. The stirring cavity is configured to remove iron from garbage, the crushing cavity is configured to crush the garbage, the flocculation cavity is configured to perform solid-liquid separation on the garbage, and the filter cavity is configured to filter sewage.

### TECHNICAL FIELD

The present disclosure relates to a field of sewage treatment, specifically a sewage treatment device for household garbage.

### BACKGROUND

Garbage is a waste article which loses use value and cannot be used. Moreover, the garbage is an important link for material circulation, and is a solid or a fluid substance which is not required or is useless. Toxic gas is unavoidably generated due to incineration of the garbage, and the incineration of the garbage further harms living bodies. Most cities study a method of reducing garbage generation and also encourage resource recycling. With continuous development of social economy, a living level of people is continuously improved. The present garbage treatment mode causes headaches for many families. Most household garbage is treated by a garbage treatment device, but the present garbage treatment device has the following defects:

Most of the present garbage treatment device crushes garbage generated in daily life of the families and then dehydrates and separates the crushed garbage. This mode can simply carry out simple treatment on the garbage. With improvement of the living level, purchasing power of people is gradually increased. The garbage may contain small articles made of iron materials, a cutter head of a crusher may be worn during crushing the garbage, which reduces working efficiency of the cutter head and a service life of the cutter head. As a result, recycling rate of scrap iron is low, and resource waste is caused. Water containing a large amount of mixed impurities and sludge is discharged after solid-liquid separation, and environmental pollution is caused. A use effect is not ideal.

### SUMMARY

In view of the prior art, the present disclosure provides a sewage treatment device for household garbage.

The sewage treatment device for household garbage of the present disclosure is provided with a machine body, a stirring cavity and a storage box. A first motor and electromagnets are turned on to enable a stirring shaft to stir garbage, so that iron materials in the garbage are adsorbed. Then the iron materials are storaged in the storage box. Recovery value for a scrap iron market is high. Compared with conventional garbage treatment devices, the sewage treatment device for household garbage not only prolongs service lives of blades, but also recycles, reprocesses and uses the scrap iron to avoid resource waste and environmental pollution. Thus, usability of the sewage treatment device for household garbage is improved.

The sewage treatment device for household garbage of the present disclosure performs flocculation when crushed garbage falls into an interior of a flocculation cavity of the sewage treatment device for household garbage. Water content separated from the garbage contains a large amount of mixed impurities and sludge. The mixed impurities and the sludge are discharged, which causes environmental pollution. The sewage treatment device for household garbage separates large-particle impurities and the sludge in the sewage and then treats the large-particle impurities and the sludge, which reduces environmental pollution caused by directly discharging the sewage. The primarily filtered sewage is filtered step-by-step through three layers of filter plates, Impurities in the sewage are effectively filtered, and the filtered water is retained for recycling. By cooperating with removing the iron materials in the garbage through stirring, completing rate of garbage recycling and sewage purification is high, environmental pollution caused by the sewage is reduces, and a use of users is facilitated.

### BRIEF DESCRIPTION OF DRAWINGS

The present disclosure will be further described with reference to the drawings and embodiments.

FIG. 1 is a schematic diagram showing a structure of a sewage treatment device for household garbage of the present disclosure;

FIG. 2 is a cross-sectional diagram showing the structure of the sewage treatment device for household garbage of the present disclosure;

FIG. 3 is a cross-sectional diagram showing a structure of a stirring cavity of the sewage treatment device for household garbage of the present disclosure;

FIG. 4 is a cross-sectional diagram showing a structure of a crushing cavity of the sewage treatment device for household garbage of the present disclosure;

FIG. 5 is an enlarged diagram of a structure of position A showing FIG. 4;

FIG. 6 is a cross-sectional diagram showing a structure of a flocculation cavity and a filter cavity of the sewage treatment device for household garbage of the present disclosure; and

FIG. 7 is an enlarged diagram of a structure of position A showing FIG. 6.

### DETAILED DESCRIPTION

In order to make the technical means, creative features, achievement goals and effects achieved by the present disclosure easy to understand, the present disclosure will be further described below in conjunction with specific embodiments.

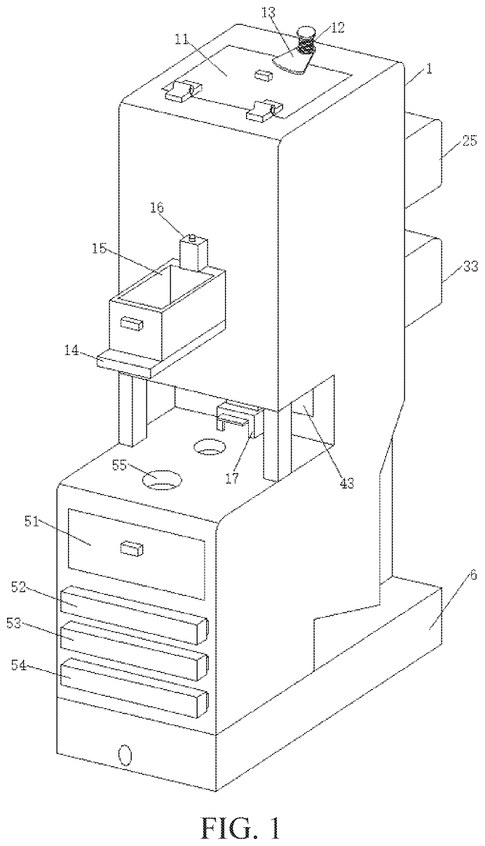

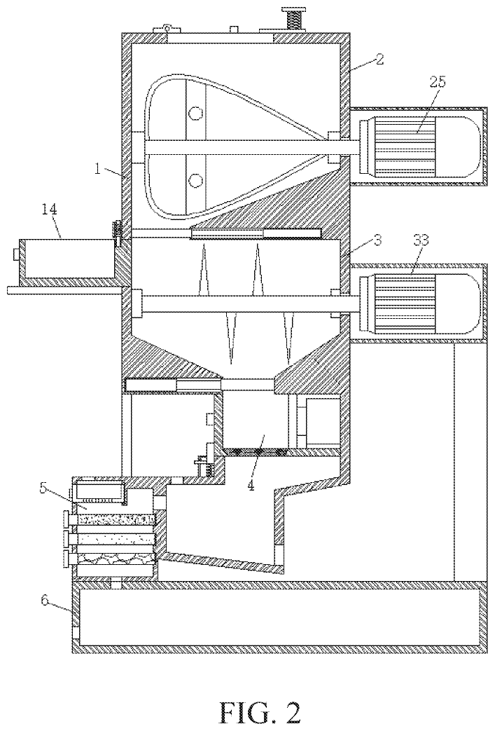

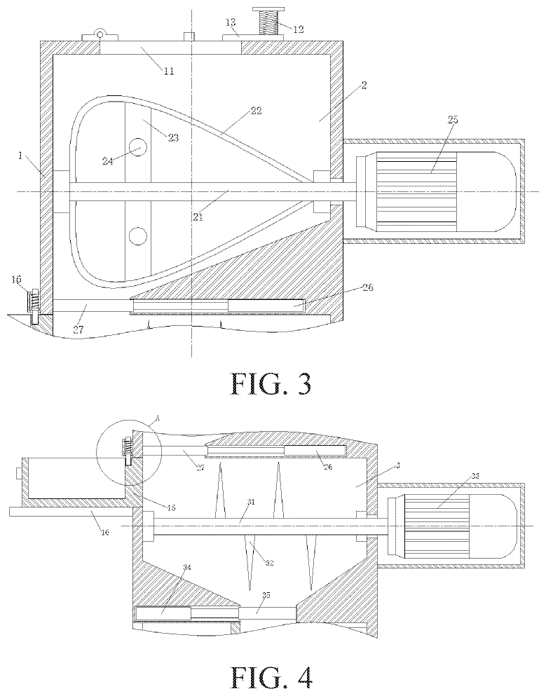

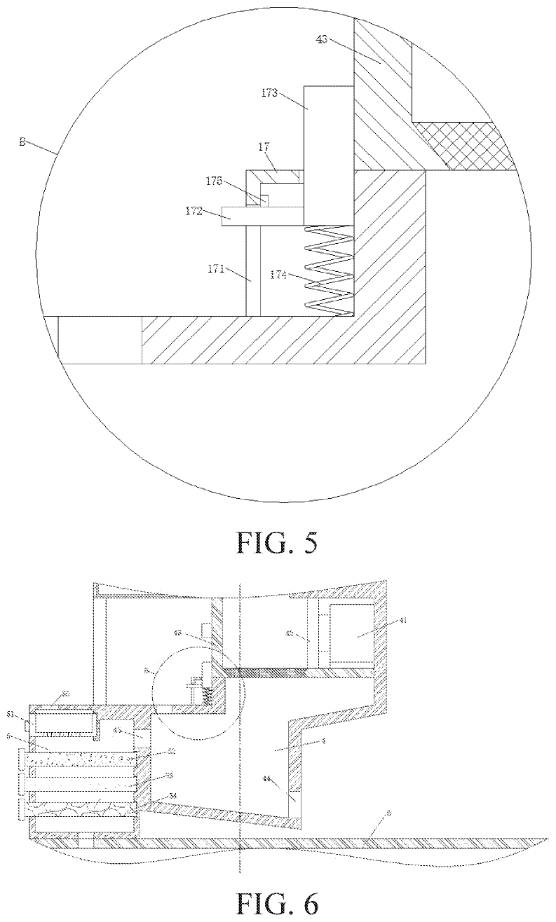

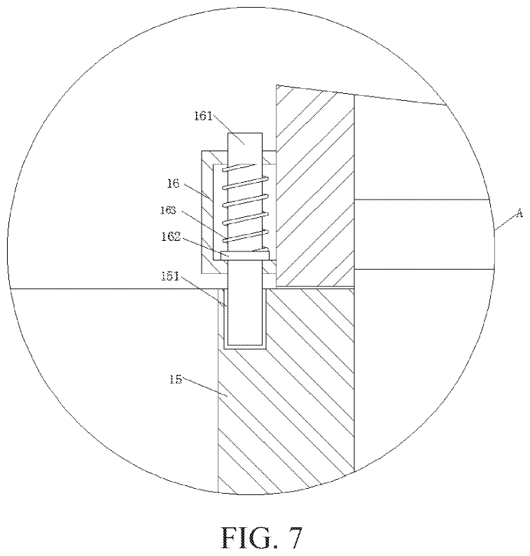

As shown in FIGS. 1-7, the present disclosure provides a sewage treatment device for household garbage, including a machine body 1, a stirring cavity 2, a crushing cavity 3, a flocculation cavity 4, a filter cavity 5, and a water tank 6. The stirring cavity 2, the crushing cavity 3, the flocculation cavity 4, and the filter cavity 5 are disposed inside the machine body 1. The stirring cavity 2 is configured to remove iron from garbage. The crushing cavity 3 is configured to crush the garbage. The flocculation cavity 4 is configured to perform solid-liquid separation on the garbage. And the filter cavity 5 is configured to filter sewage. A lower surface of the machine body 1 is fixedly connected with an upper surface of the water tank 6.

Furthermore, the machine body 1 includes a cover plate 11, a screw rod 12, an eccentric plate 13, a placing plate 14, a storage box 15, a limiting block 16, and a fixing block 17. The placing plate 14 is fixedly disposed on a left side surface of the machine body 1. The storage box 15 is movably disposed on an upper surface of the placing plate 14, A right side surface of the storage box 15 passes through a left side surface of the machine body 1 and extends to a left side surface of an inner wall of the crushing cavity 3.

Furthermore, the stirring cavity 2 includes a stirring shaft 21, stirring frames 22, connecting plates 23, electromagnets 24, a first motor 25, a first electric push rod 26 and a first baffle 27. The stirring shaft 21 is rotationally connected with an inner wall of the stirring cavity 2. The stirring frames 22 are fixedly disposed on a surface of the stirring shaft 21. A number of the stirring frames 22 is two, and the connecting plates 23 are fixedly disposed on opposite surfaces of the two stirring frames. One end of each connecting plate 23 is fixedly connected with a surface of the stirring shaft 21, and the one end of each connecting plate 23 is far away from each stirring frame 22. The electromagnets 24 are fixedly disposed on front surfaces of the connecting plates 23, and a model number of the electromagnets 24 is P80/38. A right end of the stirring shaft 21 passes through a right side surface of an inner wall of the stirring cavity 2, and the right end of the stirring shaft 21 is fixedly connected with an output shaft of the first motor 25. By setting of the machine body 1, the stirring cavity 2, and the storage box 15, when the first motor 25 and the electromagnets 24 are turned on, the stirring shaft 21 is enable to stir garbage, so that iron materials in the garbage is adsorbed. Then scrap iron is storaged in the storage box 15. The scrap iron has a high recovery value in market. Compared with conventional garbage treatment devices, the sewage treatment device for household garbage not only prolongs service live of blades 32, but also recycles, reprocesses and uses the scrap iron to avoid resource waste and environmental pollution. Thus, usability of the sewage treatment device for household garbage is improved.

Furthermore, the filter cavity 5 includes a collecting box 51, a first filter plate 52, a second filter plate 53, a third filter plate 54, and a water inlet 55. The collecting box 51, the first filter plate 52, the second filter plate 53, and the third filter plate 54 are movably disposed inside the filter cavity 5 from top to bottom in sequence. First filter holes are disposed on a lower surface of the collecting box 51. A left side surface of the collecting box 51 passes through a left side surface of an inner wall of the filter cavity 5 and extends to a left side surface of the machine body 1. A left side surface of the first filter plate 52, a left side surface of the second filter plate 53, and a left side surface of the third filter plate 54 all pass through the left side surface of an inner wall of the filter cavity 5 and extend to the left side surface of the machine body 1. The water inlet 55 is disposed on a top surface of the inner wall of the filter cavity 5.

Specifically, the cover plate 11 is hinged to an upper surface of the machine body 1. The screw rod 12 is fixedly disposed on the upper surface of the machine body 1. Surface screw threads of the screw rod 12 are connected with the eccentric plate 13, and a lower surface of the eccentric plate 13 overlaps with an upper surface of the cover plate 11. The eccentric plate 13 is rotated to be separated from the cover plate 11, and the garbage is poured into an interior of the stirring cavity 2 after the cover plate 11 is turned over. Then the eccentric plate 13 is rotated to an initial position to clamp the cover plate 11, so that the garbage is prevented from being thrown out when the stirring cavity 2 works. The eccentric plate 13 is simple and convenient to operate, and has a good fixing effect, which is convenient for users to use.

Specifically, a limiting groove 151 is disposed on an upper surface of the storage box 15. The limiting block 16 is fixedly disposed on the left side surface of the machine body 1. A limiting rod 161 is movably disposed inside the limiting block 16. A bottom end of the limiting rod 161 passes through a bottom surface of an inner wall of the limiting block 16 and extends to an inner wall of the limiting groove 151. A top end of the limiting rod 161 passes through a top surface of the inner wall of the limiting block 16 and extends to a top surface of the limiting block 16. A limiting plate 162 is sleeved on a surface of the limiting rod 161. A bottom surface of the limiting plate 162 overlaps with a bottom surface of the inner wall of the limiting block 16. A first spring 163 is sleeved on the surface of the limiting rod 161, and a bottom surface of the first spring 163 is fixedly connected with a top surface of the blocking plate 162. When other garbage falls into the crushing cavity 3, the limiting rod 161 is pulled to be separated from an interior of the limiting groove 151. The storage box 15 is pushed into an interior of the crushing cavity 3. When a half of the storage box 15 is pushed into the interior of the crushing cavity 3, the limiting rod 161 is loosened, so that the limiting rod 161 is moved back to an initial position by resilience force of the first spring 163. Thus, a left side of an inner wall of the storage box 15 is blocked by the limiting rod 161, which avoids the storage box 15 falling into the interior of the crushing cavity 3. Then the electromagnets 24 are turned off, so that the iron materials fall into the storage box 5. Then the iron materials are taken out, the scrap iron is storaged in the storage box 15. The scrap iron has a high recovery value in market. Compared with conventional garbage treatment devices, the sewage treatment device for household garbage not only prolongs service lives of blades, but also recycles, reprocesses and uses the scrap iron to avoid resource waste and environmental pollution. Thus, usability of the sewage treatment device for household garbage is improved.

Specifically, the first electric push rod 26 is fixedly disposed on the inner wall of the stirring cavity 2. An output end of the first electric push rod 26 is fixedly connected with a first baffle 27, and the first baffle 27 is located in a joint of the stirring cavity 2 and the crushing cavity 3. The crushing cavity 3 includes a rotating shaft 31, blades 32, a second motor 33, a second electric push rod 34, and a second baffle 35. The crushing cavity 3 is rotationally, connected with the rotating shaft 31. The blades 32 are fixedly disposed on a surface of the rotating shaft 31. A right end of the rotating shaft 31 passes through a right side surface of an inner wall of the crushing cavity 3 and fixedly connected with an output shaft of the second motor 33. The second electric push rod 34 is fixedly disposed on the inner wall of the crushing cavity 3. An output end of the second electric push rod 34 is fixedly connected with the second baffle 35, and the second baffle 35 is located at a joint of the crushing cavity 3 and the flocculation cavity 4. The second electric push rod 34 is turned on to drive the second baffle to block a joint of the crushing cavity 3 and the flocculation cavity 4. The first electric push rod 26 is turned off, so that the garbage after removing the iron falls into the interior of the crushing cavity 3. And then the first electric push rod 26 is turned on to drive the baffle to block the joint of the stirring cavity 2 and the crushing cavity 3. The second motor 33 is turned on to drive the rotating shaft 31 and the blades 32 to crush the garbage. When crushing is completed, the second electric push rod 34 is turned off, so that the garbage after crushing falls into an interior of the flocculation cavity 4. The sewage treatment device for household garbage crushes the garbage after removing the iron, which reduces wear rate of the blades and improves service lives and crushing efficiency.

Specifically, the flocculation cavity 4 includes a hydraulic cylinder 41, a press plate 42, a storage plate 43, a sludge discharge port 44 and a water outlet 45. The hydraulic cylinder 41 is fixedly disposed on a right side surface of an inner wall of the flocculation cavity 4. The press plate 42 is fixedly disposed on an output end of the hydraulic cylinder 41. The storage plate 43 is movably disposed inside the flocculation cavity 4. Second filter holes are disposed on a bottom of the storage plate 43. A left side surface of the storage plate 43 passes through a left side surface of the inner wall of the flocculation cavity 4 and extends to the left side surface of the machine body 1. The sludge discharge port 44 is disposed on the right side surface of the inner wall of the flocculation cavity 4. The water outlet 45 is disposed on the left side surface of the inner wall of the flocculation cavity 4. An interior of the flocculation cavity 4 is communicated with an interior of the filter cavity 5 through the water outlet 45. An adding hole is disposed on a top surface of the flocculation cavity 4. The garbage after crushing falls into the storage plate 43, and water of the garbage flows into a bottom of the flocculation 4 through the filter holes of the storage plate 43. The hydraulic cylinder 41 is turned on to drive the press plate 42 and the storage plate 43 to press the garbage, then the water of the garbage flows into the bottom of the flocculation 4. A flocculant is added from the adding hole on the top surface of the flocculation cavity 4 to settle the impurities and the sludge in the sewage in the bottom of the flocculation cavity 4, and then the impurities and the sludge in the sewage are discharged through the sludge discharge port 44. A plurality of the mixed impurities and the sludge contained in the water separated from the garbage cause the environmental pollution. The sewage treatment device for household garbage separates large-particle impurities and the sludge in the sewage and then treats the large-particle impurities and the sludge, which reduces environmental pollution caused by directly discharging the sewage.

Specifically, the fixing block 17 is fixedly disposed on the left side surface of the machine body 1. A movable hole 171 is disposed on a left side surface of the fixing block 17. An adjusting plate 172 is movably disposed inside the movable hole 171. A movable plate 173 is fixedly disposed on a right end of the adjusting plate 172. A right side surface of the movable plate 173 overlaps with the left side surface of the storage plate 43. A second spring 174 is fixedly disposed on a bottom of the movable plate 173. A stabilizing plate 175 is fixedly disposed on an upper surface of the adjusting plate 172. A size of the stabilizing plate 175 is larger than a size of the movable hole 171, and a left side surface of the stabilizing plate 175 overlaps with a left side surface of an inner wall the fixing block 17. Garbage after dehydrating is left inside the storage plate 43, and the adjusting plate 172 is pulled to drive the movable plate 173 to downwards compress the second spring 174 to separate the movable plate 173 from a joint of the movable plate 173 and the storage plate 43. The storage 43 is taken out to treat the garbage after dehydrating. After the garbage after dehydrating is treated, the storage plate is placed back to initial position. The adjusting plate 172 is loosened. The movable plate 173 is driven to automatically rebound to initial position through automatic resilience of the second spring 174, and the movable plate 173 overlaps with the storage plate 43 to tightly block the storage plate 43. The sewage treatment device for household garbage crushes the garbage and dehydrates the garbage to reduce size of the garbage, which reduce occupied space of the garbage before garbage treatment and is convenient for users to use.

Specifically, grooves are disposed on a right side surface of the filter cavity 5, and a number of the grooves is four. A right end of the collecting box 51, a right end of the first filter plate 52, a right end of the second filter plate 53, and a right end of the third plate 54 respectively overlap with interiors of the four grooves. A through hole is disposed on a bottom surface of the inner wall of the filter cavity 5. The bottom surface of the inner wall of the filter cavity 5 is communicated with an interior of the water tank 6. A water outlet is disposed on a left side surface of the water tank 6. The first filter plate 52 is a quartz sand filter plate, the second filter plate 53 is an active carbon filter plate, and the third plate is an expanded cotton filter plate. The sewage treated through the flocculation cavity 4 flows into the interior of the filter cavity 5 from the water outlet 45 and is filtered step-by-step through the first filter plate 52, the second filter plate 53, and the third filter plate 54 to effectively filter the impurities in the water. Uses can use a water pipe to make waste water generated by daily use flow into the water inlet 55. The collection box 51 primarily filters the large-particle impurities in the waste water. The collection box 51, the first filter plate 52, the second filter plate 53, and the third filter plate 54 are capable to be replaced from outside, which are convenient to be used.

Specifically, a horizontal line of an upper surface of the storage box 15 is same as a horizontal line of a top surface of the inner wall of the crushing cavity 3. A supporting rod is fixedly disposed on a lower surface of the second motor 33, and a bottom end of the supporting rod is fixedly connected with the upper surface of the water tank 6. When the storage box 15 is pushed into the interior of the crushing cavity 2, the storage box 15 is more matched with an outlet of the stirring cavity 2 and cannot collide with the blades 32 according to above description. Two protective cases are disposed outside the first motor 25 and the second motor 33. The first motor 25 and the second motor 33 are respectively disposed inside the two protective cases. Left side surfaces of the two protective cases are fixedly connected with a right side surface of the machine body 1. A cushion block is fixedly disposed on a bottom of the hydraulic cylinder 41, and a lower surface of the cushion block overlaps with the upper surface of the storage plate 43, which avoids tilting up the upper surface of the storage plate 43 when the press plate 42 is extruded with the storage plate 43 and improves stability of the storage plate 43.

When using, the first electric push pod 26 is turned on to drive the first baffle 27 to seal the bottom of the stirring cavity 2. The eccentric plate 13 is rotated to be separated from the cover plate 11, and the garbage is poured into the interior of the stirring cavity 2 after the cover plate 11 is turned over. Then the eccentric plate 13 is rotated to the initial position to clamp the cover plate 11, so that the garbage is prevented from being thrown out when the stirring cavity 2 works. The first motor 25 and the electromagnets 24 are turned on to make the stirring shaft 21 drive the stirring frames 22 to stir the garbage, so that the iron materials in the garbage are adsorbed by the electromagnets 24. The first electric push rod 26 is turned off, so that the garbage after removing the iron falls into the interior of the crushing cavity 3. When other garbage falls into the crushing cavity 3, the limiting rod 161 is pulled to be separated from an interior of the limiting groove 151. The storage box 15 is pushed into the interior of the crushing cavity 3. When the half of the storage box 15 is pushed into the interior of the crushing cavity 3, the limiting rod 161 is loosened, so that the limiting rod 161 is moved back to the initial position by the resilience force of the first spring 163. Thus, the left side of the inner wall of the storage box 15 is blocked by the limiting rod 161, which avoids the storage box 15 from falling into the interior of the crushing cavity 3. Then, the electromagnets 24 are turned off, so that the iron materials fall into the storage box 15. Then the iron materials are taken out, the storage of the scrap iron is completed. And then the first electric push rod 26 is turned on to drive the baffle to block the joint of the stirring cavity 2 and the crushing cavity 3. The second motor 33 is turned on to drive the rotating shaft 31 and the blades 32 to crush the garbage. When crushing is completed, the second electric push rod 34 is turned off, so that the garbage after crushing falls into the interior of the flocculation cavity 4. The garbage after crushing falls into the storage plate 43, and water of the garbage flows into the bottom of the flocculation 4 through the filter holes of the storage plate 43. The hydraulic cylinder 41 is turned on to drive the press plate 42 and the storage plate 43 to press the garbage, then the water of the garbage flows into the bottom of the flocculation 4. The flocculant is added from the adding hole on the top surface of the flocculation cavity 4 to settle the impurities and the sludge in the sewage in the bottom of the flocculation cavity 4, and then the impurities and the sludge in the sewage are discharged through the sludge discharge port 44. After the garbage after dehydrating is treated, the storage plate is placed back to the initial position. The adjusting plate 172 is loosened. The movable plate 173 is driven to automatically rebound to the initial position through the automatic resilience of the second spring 174, and the movable plate overlaps with the storage plate 43 to tightly block the storage plate 43. The sewage treated through the flocculation cavity 4 flows into the interior of the filter cavity 5 from the water outlet 45 and is filtered step-by-step through the first filter plate 52, the second filter plate 53, and the third filter plate 54 to effectively filter the impurities in the water. Users can use the water pipe to make the waste water generated by daily use flow into the water inlet 55. The collection box 51 primarily filters the large-particle impurities in the waste water. The collection box 51, the first filter plate 52, the second filter plate 53, and the third filter plate 54 are capable to be replaced from outside. Operation of the sewage treatment device for household garbage is completed by above descriptions.

The basic principles, main features and advantages of the present disclosure are shown and described above. It should be understood by those skilled in the art that the present disclosure is not limited by the foregoing embodiments. The above description of the embodiments and the description are merely illustrative of the principles of the present disclosure. There are various variations and modifications of the present disclosure without departing from the spirit and scope of the present disclosure. The scope of the present disclosure is defined by the appended claims and their equivalents.

What is claimed is:

1. A sewage treatment device for household garbage, comprising a machine body, a stirring cavity, a crushing cavity, a flocculation cavity, a filter cavity, and a water tank;
wherein the stirring cavity, the crushing cavity; the flocculation cavity, and the filter cavity are disposed inside the machine body; the stirring cavity is configured to remove iron from garbage, the crushing cavity is configured to crush the garbage, the flocculation cavity is configured to perform solid-liquid separation on the garbage, and the filter cavity is configured to filter sewage; a lower surface of the machine body is fixedly connected with an upper surface of the water tank;
wherein the machine body comprises a cover plate, a screw rod, an eccentric plate, a placing plate, a storage box, a limiting block, and a fixing block; the placing plate is fixedly disposed on a left side surface of the machine body; the storage box is movably disposed on an upper surface of the placing plate; a right side surface of the storage box passes through a left side surface of the machine body and extends to a left side surface of an inner wall of the crushing cavity;
wherein the stirring cavity comprises a stirring shaft, stirring frames, connecting plates; electromagnets, a first motor; a first electric push rod, and a first baffle; the stirring shaft is rotationally connected with an inner wall of the stirring cavity; the stirring frames are fixedly disposed on a surface of the stirring shaft; a number of the stirring frames is two, and the connecting plates are fixedly disposed on opposite surfaces of the two stirring frames; one end of each connecting plate is fixedly connected with a surface of the stirring shaft, and the one end of each connecting plate is far away from each stirring frame; the electromagnets are fixedly disposed on front surfaces of the connecting plates; a right end of the stirring shaft passes through a right side surface of an inner wall of the stirring cavity, and the right end of the stirring shaft is fixedly connected with an output shaft of the first motor;
wherein the filter cavity comprises a collecting box, a first filter plate, a second filter plate, a third filter plate, and a water inlet; the collecting box, the first filter plate, the second filter plate, and the third filter plate are movably disposed inside the filter cavity from top to bottom in sequence; first filter holes are disposed on a lower surface of the collecting box; a left side surface of the collecting box passes through a left side surface of an inner wall of the filter cavity and extends to a left side surface of the machine body; a left side surface of the first filter plate, a left side surface of the second filter plate, and a left side surface of the third filter plate all pass through the left side surface of an inner wall of the filter cavity and extends to the left side surface of the machine body; the water inlet is disposed on a top surface of the inner wall of the filter cavity.

2. The efficient sewage treatment device for household garbage according to claim 1, wherein the cover plate is hinged to an upper surface of the machine body; the screw rod is fixedly disposed on the upper surface of the machine body; surface screw threads of the screw rod are connected with the eccentric plate; and a lower surface of the eccentric plate overlaps with an upper surface of the cover plate.

3. The efficient sewage treatment device for household garbage according to claim 1, wherein a limiting groove is disposed on an upper surface of the storage box; the limiting block is fixedly disposed on the left side surface of the machine body; a limiting rod is movably disposed inside the limiting block; a bottom end of the limiting rod passes through a bottom surface of an inner wall of the limiting block and extends to an inner of the limiting groove; a top end of the limiting rod passes through a top surface of the inner wall of the limiting block and extends to a top surface of the limiting block; a limiting plate is sleeved on a surface of the limiting rod; a bottom surface of the limiting plate overlaps with a bottom surface of the inner wall of the limiting block; a first spring is sleeved on the surface of the limiting rod; and a bottom surface of the first spring is fixedly connected with a top surface of the blocking plate.

4. The efficient sewage treatment device for household garbage according to claim 1, wherein the first electric push rod is fixedly disposed on the inner wall of the stirring cavity; an output end of the first electric push rod is fixedly connected with a first baffle; and the first baffle is located in a joint of the stirring cavity and the crushing cavity.

5. The efficient sewage treatment device for household garbage according to claim 1, wherein the crushing cavity comprises a rotating shaft, blades, a second motor, a second electric push rod, and a second baffle; the inner wall of the crushing cavity is rotationally connected with the rotating shaft; the blades are fixedly disposed on a surface of the rotating shaft; a right end of the rotating shaft passes through a right side surface of the inner wall of the crushing cavity and fixedly connected with an output shaft of the second motor; the second electric push rod is fixedly disposed on the inner wall of the crushing cavity; an output end of the second electric push rod is fixedly connected with the second baffle; and the second baffle is located at a joint of the crushing cavity and the flocculation cavity.

6. The efficient sewage treatment device for household garbage according to claim 1, wherein the flocculation cavity comprises a hydraulic cylinder, a press plate, a storage plate, a sludge discharge port and a water outlet; the hydraulic cylinder is fixedly disposed on a right side surface of an inner wall of the flocculation cavity; the press plate is fixedly disposed on an output end of the hydraulic cylinder; the storage plate is movably disposed inside the flocculation cavity; second filter holes are disposed on a bottom of the storage plate; a left side surface of the storage plate passes through a left side surface of the inner wall of the flocculation cavity and extends to the left side surface of the machine body; the sludge discharge port is disposed on the right side surface of the inner wall of the flocculation cavity; the water outlet is disposed on the left side surface of the inner wall of the flocculation cavity=; an interior of the flocculation cavity is communicated with an interior of the filter cavity through the water outlet; an adding hole is disposed on a top surface of the flocculation cavity.

7. The efficient sewage treatment device for household garbage according to claim 1, wherein the fixing block is fixedly disposed on the left side surface of the machine body; a movable hole is disposed on a left side surface of the fixing block; an adjusting plate is movably disposed inside the movable hole; a movable plate is fixedly disposed on a right end of the adjusting plate; a right side surface of the movable plate overlaps with the left side surface of the storage plate; a second spring is fixedly disposed on a bottom of the movable plate; a stabilizing plate is fixedly disposed on an upper surface of the adjusting plate; a size of the stabilizing plate is larger than a size of the movable hole; and a left side surface of the stabilizing plate overlaps with a left side surface of an inner wall the fixing block.

8. The efficient sewage treatment device for household garbage according to claim 1, wherein grooves are disposed on a right side surface of the filter cavity, and a number of the grooves is four; a right end of the collecting box, a right end of the first filter plate, a right end of the second filter plate, and a right end of the third plate respectively overlap with interiors of the four grooves; a through hole is disposed on a bottom surface of the inner wall of the filter cavity, the bottom surface of the inner wall of the filter cavity is communicated with an interior of the water tank; and a water outlet is disposed on a left side surface of the water tank.

9. The efficient sewage treatment device for household garbage according to claim 4, wherein a horizontal line of an upper surface of the storage box is same as a horizontal line of a top surface of the inner wall of the crushing cavity; a supporting rod is fixedly disposed on a lower surface of the second motor; and a bottom end of the supporting rod is fixedly connected with the upper surface of the water tank.
